(19) United States
(12) Patent Application Publication
(10) Pub. No.: US 2010/0235222 A1
(43) Pub. Date: Sep. 16, 2010

(54) SYSTEM AND METHOD FOR EVALUATING SALES MARKETS

(76) Inventor: Patrick T. Farley, Dallas, TX (US)

Correspondence Address: Patrick T. Farley, 5818 Velasco Ave., Dallas, TX, 75206, US

(21) Appl. No.: 12/404,052

(22) Filed: Mar. 13, 2009

(51) Int. Cl. G06Q 30/00; G06F 17/30

(52) U.S. Cl. 705/10

(57) ABSTRACT

A system and method for comparing prices of products or services between multiple markets and for analyzing the amount of time a specific product or products takes to sell in a specific market.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

1. Field of the Invention Art

The present invention relates generally to the evaluation of one or more sales markets and more particularly, to a system and method for comparing prices of a product(s) or service(s) between multiple markets and for analyzing the amount of time a specific product or products takes to sell in a specific market.

2. Description of the Related Art

When a business is involved in commerce between multiple markets, it is important for the business to have accurate information about the value of products within each market to decide which product or products to sell in which market and what to charge for the product(s). In addition, it is important for a business to know how long each product under consideration typically remains on the market before being sold (“sale cycle time”).

For example, a company in the business of importing and/or exporting products between countries is relying on the fact that a specific product may be considered more valuable in one country than in another and thus, may command a greater price. In order for an import/export company to select a product to sell and where to sell it, the company needs to have information regarding how much various potential products are worth in each country. Also, in selecting which product a company will sell, it is important for the company to have information regarding how long each product under consideration typically takes to sell in a given country and at what price.

Currently, the only way for a business to evaluate the price differential of a product between multiple markets is to manually research the prices of various products in multiple markets, either by phone, in person, or via the Internet. Further, this problem is exacerbated when a business is trying to decide which product or products to sell out of a large number of possibilities. Trying to determine which product out of several products has the greatest price differential between markets can be extremely difficult and time consuming to perform manually.

The problem is yet further exacerbated when a business is also concerned with how long a potential product could take to sell, either to establish inventory control or to help decide which product(s) to sell. For example, an import/export company may factor in how long a specific product would likely take to sell, in addition to how much profit that product might command, when deciding whether to sell a product or which product to sell. A company would likely strive to maximize profit per product while minimizing sales cycle time. Also, in order for an import/export company to maintain a predictable and constant level of inventory, it is very important to have an estimate of how long each specific product will take to sell in that market. This knowledge informs the company when to ship a replacement product(s). Because of the long period of time intercontinental shipments often take, this knowledge can be crucial.

Thus, a need exists for a system and method to determine the cost differential between markets for one or more products and to determine the average sale time for various products in a specific market.

### SUMMARY OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a method for comparing pricing between markets, comprising: retrieving a first cost value from a first market; retrieving a second cost value from a second market; and utilizing at least said first cost value and said second cost value to compare pricing between said first market and said second market, wherein said retrieving is from an electronic database, and wherein said retrieving is by a computer.

It is a further object of the present invention to provide a system comprising: a processor and memory into which a plurality of instructions are loaded, the plurality of instructions performing a method for comparing pricing between markets, comprising: retrieving a first cost value from a first market; retrieving a second cost value from a second market; and utilizing at least said first cost value and said second cost value to compare pricing between said first market and said second market, wherein said retrieving is from an electronic database, and wherein said retrieving is by a computer.

It is yet a further object of the present invention to provide a method for comparing product pricing between geographical markets via the Internet, comprising: extracting a first price from a first geographical market; extracting a second price from a second geographical market; utilizing at least said first price and said second price to compare pricing between said first geographical market and said second geographical market, wherein said extracting is from one or more Internet databases and is performed by an Internet macro.

It is another object of the present invention to provide a method for determining the amount of time multiple products stay available on a market, comprising: retrieving at least one product listing from an electronic database at one of multiple points in time; populating one or more output files with said product listing; and repeating the process of retrieving at least one product listing multiple times at proscribed time intervals.

These together with other objects of the invention, along with the various features of novelty which comprise the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

It should be understood that any one of the features of the invention may be used separately or in combination with other features. It should be understood that features which have not been mentioned herein may be used in combination with one or more of the features mentioned herein. Other systems, methods, features, and advantages of the present invention will be or become apparent to one with skill in the art upon examination of the drawings and detailed description. It is intended that all such additional systems, methods, features, and advantages be included within this description, be within the scope of the present invention, and be protected by the accompanying claims.

### BRIEF DESCRIPTION OF THE SERIAL VIEWS OF DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which:

FIG. 1 provides a flowchart of an embodiment of the process of extracting prices of products for comparison between markets.

FIG. 2 provides a flowchart of an embodiment of the process of extracting information for various products from a website for later comparison of product sales cycle times.

FIG. 3 provides a flowchart of an embodiment of the process of compiling the product information from multiple points in time and determining the amount of time each product remained on the market before being sold.

### DETAILED DESCRIPTION OF THE INVENTION

The following discussion is presented to enable a person skilled in the art to make and use the invention. The principles described herein can be applied to embodiments and applications other than those detailed below without departing from the spirit and scope of the present invention as defined by the appended claims. The present invention is not intended to be limited to the embodiments shown, but is to be accorded the widest scope consistent with the principles and features disclosed herein.

In one embodiment of the present invention, a computer program (or programs) retrieves information from a database, such as an online database, regarding the pricing of various products in multiple markets to determine the price differential between markets for each product. This is done to enable a user to recognize which of the assortment of products will yield the greatest profit when sold between markets.

Further, in an embodiment of the present invention, a computer program retrieves product information for all products listed in a database for sale, such as from an online database. The computer program performs this process repeatedly at a preset interval of time. After a certain amount of time, all of the results from all of the retrievals are compiled and evaluated to determine the amount of time each product stayed on the market before being sold.

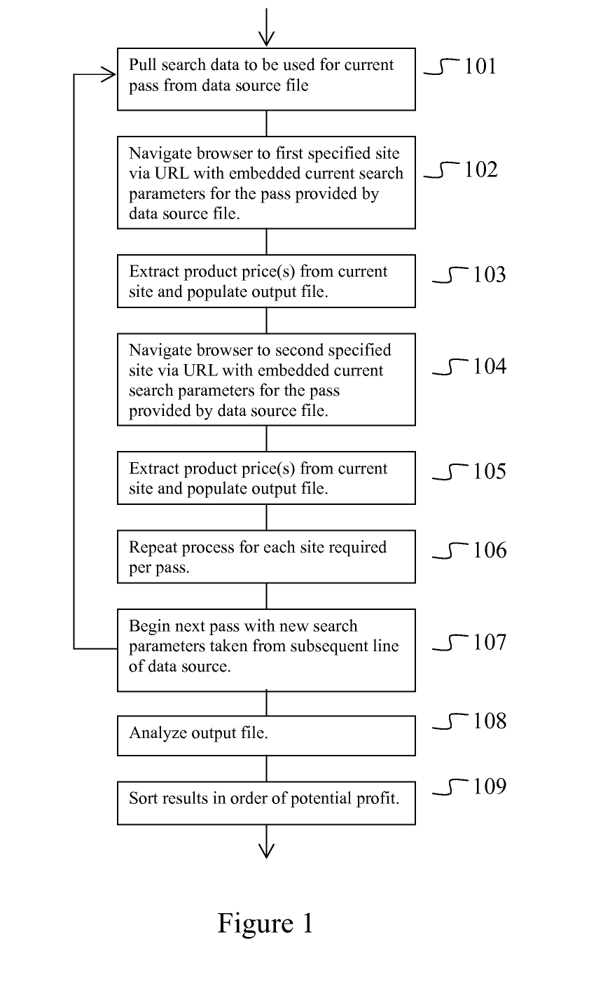

Referring now to the figures and initially to FIG. 1, in an embodiment of the present invention, a computer program performs predetermined searches of online databases that provide listings of products for sale, such as AutoTrader™ (www.autotrader.com) or Craigslist™ (www.craigslist.com). In an embodiment of the invention, the program pulls search data from a file 101, such as a comma separated values (“CSV”) file or an Excel™ spreadsheet file. For example, the product could be a car and one of the website databases to be searched may be an automobile listing website, such as AutoTrader™. In this example, the search data might be the make, model, and year of the car to be searched. The data source file would contain all make/model/year combinations that are desired to be evaluated.

In one embodiment of the invention, the program pulls the first set of search data from the data source file 101. The program navigates an Internet browser to a desired website to be queried 102. The first set of search data (search terms) are utilized to direct the browser to obtain the appropriate search results of the website. In one embodiment, the program selects the appropriate ‘pulldown’ menus to select the appropriate combination of search terms and executes the search within the webpage. In an alternative embodiment, the program embeds the search terms within the website URL to navigate to a website's search results directly. In the example of comparing automobile pricing between markets, a URL with embedded search terms would look something like this:

“http://www.autotrader.com/fyc/searchresults.jsp?num_records=25&search_lang=en&page_location=findacar%3A%3Aispsearchform&search_type=both&distance=0&address=75206&marketZipError=false&style_flag=1&make=HONDA&model=CIVIC&make2=&start_year=1999&end_year=1999”

The search terms that are embedded into this example URL are in bold above (“Honda”, “Civic”, and “1999”). The entry of this URL will yield a search within AutoTrader™ of all 1999 Honda™ Civic's in the United States.

In an embodiment of the invention, the program next extracts one or more product prices and populates an output file with those values 103. In an embodiment, this output file is a CSV file or an Excel™ spreadsheet file. In a further embodiment, the program also populates the output file with the corresponding search data. For example, in the car comparison example, the output file might have a line providing “Honda, Civic, 1999, 6995”. This would show that one 1999 Honda Civic costs $6995 in the United States.

In an embodiment of the invention, the program would next navigate to another website listing products in a different market 104. The same search would be repeated in this website, and the price value(s) would be extracted similarly 105. In the example of comparing car prices between markets, the program would perform a search of the same make/model/year combination in another market. For example, in the Honda™ Civic example, the search may then be performed within a website listing cars for sale in another country, such as Spain or China.

In an embodiment, this process would be repeated for all of the websites (representing all desired markets) to be queried 106. After all desired websites are searched and all required data extracted for the first search data (e.g., Honda, Civic, 1999), the process starts again for the next search data in the data source file (e.g. Honda, Accord, 1999) 107. The process repeats until all data search terms have been processed (i.e., until all products have been queried for all markets). In the example of the car price comparison between markets, the output file would contain all make/model/year combinations and the associated prices for each country (or region) searched.

In another embodiment, several prices are extracted per search (e.g., make/model/year) and the prices are averaged to yield an average price for that product (e.g., make/model/year car) in that market. In an alternative embodiment, if an average price of the searched product is provided by the website itself, that price is extracted from the site.

In an embodiment, after all searches of all products in all desired markets is performed, the program's output file can be analyzed 108. In the example of the car price comparison, the output file will list all make/model/year combinations and the associated average prices for each country searched. These results can be evaluated in a spreadsheet or by the program itself. In the example of using a spreadsheet, the results can be evaluated to determine which product(s) should be sold in which market(s). In the car example, an equation can be set up in the spreadsheet to subtract the price each make/model/year car costs in one country and subtract it from what the same car would cost in another country. All of these calculations would be performed simultaneously by the spreadsheet (or internal to the program). In another embodiment, other values can be taken into consideration, such as shipping costs and the exchange rate between countries' currencies. In an embodiment, a computed cost differential between markets is associated with each product (e.g., make/model/year car) and those cost differentials can be sorted by the spreadsheet program (or internal to the program) 109. The order of the final results would communicate to a company which products would likely yield the highest profit if sold between the specified markets. In an alternative embodiment, the results could be sorted by cost differential divided by initial investment. This would normalize profits to determine which product makes the most sense to sell, regardless of price point. In other words, the results would be sorted in order of percentage return (of investment), as opposed to absolute profit.

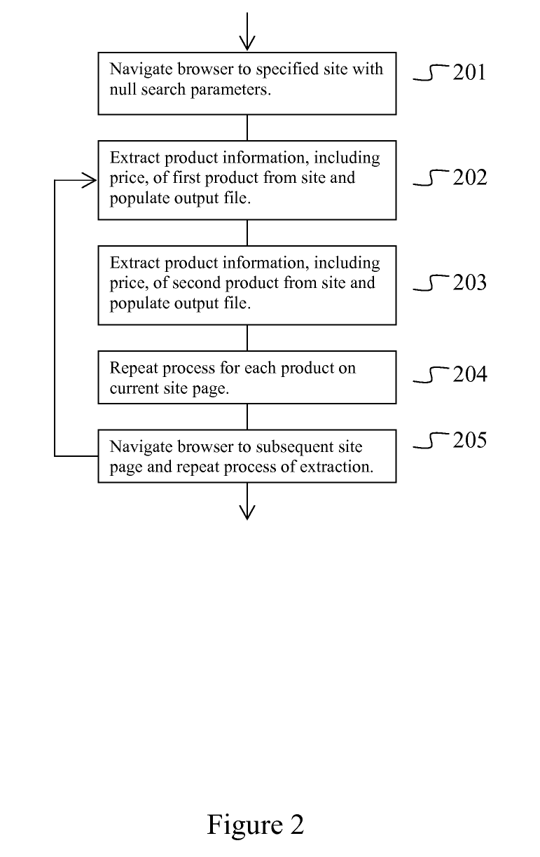

With reference now to FIG. 2, in an embodiment of the present invention, the program (or a separate program or programs) navigates the browser to a specified website, listing products for sale in a specific market 201, and performs a null search to yield all results in the site's database. In the example of analyzing car sales in other markets, the browser is navigated to a website listing cars for sale. The website is queried with no search parameters (i.e., no limitations to the query). Similar to above, this can be done by the program selecting pulldown menus (e.g., choosing “All” as the pulldown selection(s)) within the website or by embedding the null search terms into the URL. An example of this is as follows:

“http://www.autotrader.com/fyc/searchresults.jsp?num_records=25&search_lang=en&page_location=findacar%3A%3Aispsearchform&search_type=both&distance=0&address=75206&marketZipError=false&style_flag=1&make=&model=&start_year=&end_year=”

As seen above, there is no value inserted after the make, model, and year parameters. Therefore, the results would be all cars of all years for sale in the United States (or whatever market one is interested in).

In an embodiment of the invention, product information is extracted and outputted to an output file 202 for each product listed on the website page 203 and 204. Once all necessary product information for each product is extracted from the first page, the browser navigates to the next page of the search results and repeats the process 205. The process is repeated until all results are extracted and exported to populate the output file.

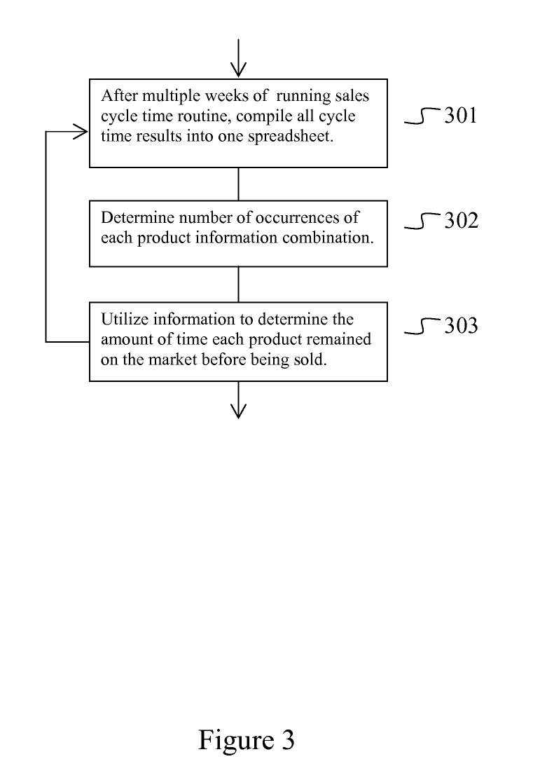

With reference now to FIG. 3, in an embodiment of the present invention, the process described in FIG. 2 is repeated at specified time intervals 301. After the program has run multiple times over a certain amount of time, the output file(s) is utilized to determine how many occurrences of a specific product is listed in the compilation output file 302. In an embodiment, the number of occurrences of each product is used to determine the amount of time each product remained on the market before being sold 303.

In the example of evaluating car sales in other countries, the program performs a null search in a website listing cars for sale. The program extracts and outputs to a file all specified information. For example, the make, model, year, mileage, and price for each car might be exported to the output file. Information such as mileage and price is helpful to provide a unique identification for each car (or product), as explained below. The program may be performed automatically at proscribed intervals, for example once per week. After a certain amount of time, the results can be evaluated to determine sales cycle times for each car.

In one embodiment of the invention, sales cycle times are evaluated by the program. In an alternative embodiment, the sales cycle time are determined with the use of a spreadsheet. In an embodiment, all output files are combined into one file, such as an Excel™ spreadsheet. A formula is performed within the spreadsheet to determine the number of occurrences of each evaluated product within the output file (e.g., the number of each make/model/year/mileage/price combination). The number of occurrences of each product represents the amount of time each product stayed on the market before being sold.

In the example of evaluating car sales in other countries, if the specified time interval between program runs is one week, each week the program populates the output file(s) with all cars listed for sale by that website at that time. After several weeks, all results are combined into a single file. The middle result (the result at the middle of the time span) can be utilized to perform a counting of all matching results across the entire output file. In the example of using an Excel™ spreadsheet to evaluate the output, the column of car information in the middle of the time scale is copied and pasted into a separate tab, and a function, such as “countif” is utilized to determine the number of times each specific make/model/year/mileage/price combination occurs on the following tab. The result of the function will be a number representing the number of weeks each car listed in the middle column (middle week) remained listed on the website. It can be assumed that the number of weeks each car listing remained accessible on the website represents the number of weeks the car took to sell. In an alternative embodiment, the program itself evaluates the output program in a similar manner to determine the number of weeks each car remained on the market before being sold.

In an embodiment of the present invention, the program is an instruction set controlling an Internet macro application, such as iMacros™ by iOpus™. In an embodiment, the instruction set is programmed in a language such as Visual Basic. In an embodiment, the instruction set is utilized by the Internet macro to perform the foregoing described sequence of routines.

In an embodiment, the program is instructed to perform these various processes automatically at specified intervals. The performance of these processes at specified times or intervals is controlled in an embodiment by a scheduler. For example, the Windows™ operating system provides the Windows Scheduler™, which can be programmed to perform specific routines or run specific programs at specified times, dates, or intervals.

In an embodiment, the cost differential routine is performed monthly to monitor and to track trends of which products provide the greatest percentage return (or greatest profit, etc.). In an embodiment, the sales cycle time routine is performed each week to provide estimated sales cycle time in terms of ‘weeks on the market’.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention.

In addition, while a particular feature of the invention may have been disclosed with respect to only one of several embodiments, such feature may be combined with one or more other features of the other embodiments as may be desired. Additionally, for the most part, details concerning particular chemical reactions, chemical properties, and the like, have been omitted inasmuch as such details are not considered necessary to obtain a complete understanding of the present invention, and are considered to be within the understanding of persons of ordinary skill in the relevant art.

It is therefore, contemplated that the claims will cover any such modifications or embodiments that fall within the true scope of the invention.

What is claimed is:

1. A method for comparing pricing between markets, comprising:
retrieving a first cost value from a first market;
retrieving a second cost value from a second market; and
utilizing at least said first cost value and said second cost value to compare pricing between said first market and said second market,
wherein said retrieving is from an electronic database, and
wherein said retrieving is by a computer.

2. The method of claim 1, wherein said first cost value and one or more other cost values are averaged to establish a first market average.

3. The method of claim 2, wherein said first market average is utilized in a pricing comparison between said first market and said second market.

4. The method of claim 3, wherein said electronic database is accessed via the Internet.

5. The method of claim 4, wherein
said retrieving is performed by an Internet macro;
said Internet macro navigates to one or more Internet databases to extract said cost values from said Internet databases; and
said retrieving is performed by extracting cost values from said Internet database.

6. The method of claim 5, further comprising:
populating an output file with said cost values.

7. The method of claim 6, wherein
said output file is a spreadsheet file, and
said comparing is enabled by a spreadsheet program.

8. The method of claim 7, wherein said first cost value is associated to a product in said first market and said second cost value is associated to said product in said second market.

9. The method of claim 8, wherein said first market is in a first region of the world and said second market is in a second region of the world.

10. A system comprising: a processor and memory into which a plurality of instructions are loaded, the plurality of instructions performing a method for comparing pricing between markets, comprising:
retrieving a first cost value from a first market;
retrieving a second cost value from a second market; and
utilizing at least said first cost value and said second cost value to compare pricing between said first market and said second market,
wherein said retrieving is from an electronic database, and
wherein said retrieving is by a computer.

11. The system of claim 10, wherein
said first cost value and one or more other cost values are averaged to establish a first market average, and
said first market average is utilized in a pricing comparison between said first market and said second market.

12. The system of claim 11, wherein
said retrieving is performed by an Internet macro;
said Internet macro navigates to one or more Internet databases to extract said cost values from said Internet databases; and
said retrieving is performed by extracting cost values from said Internet database.

13. The system of claim 12, wherein said first cost value is associated to a product in said first market and said second cost value is associated to said product in said second market.

14. The system of claim 13, wherein said first market is in a first region of the world and said second market is in a second region of the world.

15. A method for comparing product pricing between geographical markets via the Internet, comprising:
extracting a first price from a first geographical market;
extracting a second price from a second geographical market;
utilizing at least said first price and said second price to compare pricing between said first geographical market and said second geographical market,
wherein said extracting is from one or more Internet databases and is performed by an Internet macro.

16. The method of claim 15, wherein
said first price and one or more other prices are averaged to establish a first market average for the product, and
said first market average is utilized in a pricing comparison between said first geographical market and said second geographical market.

17. The method of claim 16, further comprising:
populating a spreadsheet file with said prices, wherein
said comparing is enabled by a spreadsheet program.

18. A method for determining the amount of time multiple products stay available on a market, comprising:
retrieving at least one product listing from an electronic database at one of multiple points in time;
populating one or more output files with said product listing; and
repeating the process of retrieving at least one product listing multiple times at proscribed time intervals.

19. The method of claim 18, wherein said electronic database is an Internet database and said retrieving is by an Internet macro.

20. The method of claim 19, further comprising:
counting the number of occurrences of the product listing within said one or more output files.

21. The method of claim 20, wherein
said output file is a spreadsheet file;
said counting the number of occurrences is performed by a spreadsheet function; and
said counting the number of occurrences is performed to determine the amount of time said product was available.

22. A system comprising: a processor and memory into which a plurality of instructions are loaded, the plurality of instructions performing a method for determining the amount of time multiple products stay available on a market, comprising:
retrieving at least one product listing from an electronic database at one of multiple points in time;
populating one or more output files with said product listing;
repeating the process of retrieving at least one product listing multiple times at proscribed time intervals; and
counting the number of occurrences of the product listing within said one or more output files.

23. The method of claim 22, wherein
said output file is a spreadsheet file;
said counting the number of occurrences is performed by a spreadsheet function; and
said counting the number of occurrences is performed to determine the amount of time said product was available.

24. The method of claim 23, wherein said electronic database is an Internet database and said retrieving is by an Internet macro.
